(19) United States
(12) Patent Application Publication
(10) Pub. No.: US 2010/0300306 A1
(43) Pub. Date: Dec. 2, 2010

(54) INDOOR GRILL GRID APPARATUS

(76) Inventor: Raesung Son, Fort Lee, NJ (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/540,151

(22) Filed: Aug. 12, 2009

Related U.S. Application Data
(60) Provisional application No. 61/182,579, filed on May 29, 2009.

(51) Int. Cl. A47J 37/06

(52) U.S. Cl. 99/401

(57) ABSTRACT

An indoor grill grid apparatus is provided to allow a user to grill various foods indoor, such as in a restaurant, a home, a commercial kitchen and the like, using a conventional indoor grill and stream. In one embodiment, the indoor grill grid apparatus comprises a cooking component, a water tank and a steam component. The steam component comprises several steam outlets which have openings on the surface thereon. The openings are provided such a way that stream can be supplied to the cooking component, thereby the stove heat and steam provided to the apparatus substantially at the same time, the food can be prevented from being overcooked, burned or sticking to the cooking component. Further, the combination of the steam and the stove heat prevents any food residue from being left on the cooking component so that fumes can be minimized.

### CROSS-REFERENCE TO RELATED APPLICATION

This application claims the benefit of U.S. Provisional Application No. 61/182,579, filed May 29, 2009, expressly incorporated herein by reference in its entirety.

### BACKGROUND

There are many restaurants where customers can enjoy their own BBQ grilling at the table. Most of those restaurants install or provide a stove burner on the table and place a grid or grant on the stove burner to allow customers to grill the food on the grid or grant at their own tables. The stove burner is generally built-into the table or a portable burner, using gas, electric or special charcoals.

One of the problems of indoor grilling is generating fumes. Thus, a fan is usually operated to disperse fumes generated from the indoor grilling. However, the fan can be very noisy and consumes energy. Further, it is hard to eliminate the fumes completely using the fan. The fumes trapped inside the restaurant or house can be a health hazard and create an unpleasant environment for dining. Most fumes are generally caused by the food itself attaching to the surface of the grid, or the food residue and fat left on the surface of the grid in between grilling, which tend to be burnt due to the heat of the grill. Accordingly, there is a need for an indoor grill grid that prevents fumes from being generated.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with an aspect of one embodiment, a grid apparatus suitable for indoor grilling is provided. A grid apparatus comprises a cooking component provided for placing and cooking food thereon, a steam component and a water tank. The cooking component comprises a plurality of elongated members connected to the water tank. Each elongated member comprises a water inlet for receiving water from a water tank and a hollow interior where the water can flow from the water tank through the water inlet. As the cooking component is heated by a stove burner and the cooking component reaches a boiling temperature, the water is vaporized to steam, thereby steam being generated within the hollow interior of the elongated member. The steam component includes a steam reservoir for receiving steam, the steam reservoir including a plurality of steam inlets, each steam inlet coupled to an opening disposed at a side of a corresponding elongated member of the cooking component and a steam supply member including a surface where a plurality of steam outlets are provided thereon, the steam supply member coupled to the steam reservoir. After a steam pressure is built within the steam reservoir, the steam fills the steam supply member, thereby steam flowing out from the steam supply member through the plurality of steam outlets.

In accordance with another aspect, a grant apparatus suitable for indoor grilling is provided. The grant apparatus comprises a cooking component, a steam component and a water tank. The cooking component includes a plurality of elongated members connected to the water tank, each elongated member comprising a hollow interior for carrying the water supplied from the water tank through the opening. As the cooking component reaches a boiling temperature, the water contained in the elongated member is vaporized, thereby steam being generated within the hollow interior of the elongated member. The steam component includes a surface area where a plurality of steam outlets provided thereon, each steam outlet including an opening for supplying the steam upwardly so that the elongated members of the cooking component are exposed to the steam. The steam component includes a cavity or a hollow interior for receiving the steam from the elongated member of the cooking component. The steam flows into the steam component once the water contained in the elongated members is vaporized.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective view of an exemplary indoor grill grid apparatus in accordance with the disclosed subject matter of the present application;

FIG. 2 is a top view of the exemplary indoor grill grid apparatus of FIG. 1;

FIG. 3 is a bottom view of the exemplary indoor grill grid apparatus of FIG. 1;

FIG. 4 is a perspective view of another exemplary indoor grill grid apparatus in accordance with the subject matter of the present application;

FIG. 5 is a top view of the exemplary indoor grill grid apparatus of FIG. 4; and

FIG. 6 is a cross sectional view of the exemplary indoor grill grid apparatus of FIG. 4.

### DETAILED DESCRIPTION

The detailed description set forth below in connection with the appended drawing is intended as a description of various embodiments of the disclosed subject matter and is not intended to represent the only embodiments.

Generally stated, an indoor grill grid apparatus is provided to allow a user to grill various foods indoors, such as in a restaurant, a home, a commercial kitchen, a residential kitchen, and the like, without generating fumes. Each embodiment described in this disclosure is provided merely as an example or illustration and should not be construed as preferred or advantageous over other embodiments. In this regard, the following description provides an overview of an indoor grill grid apparatus. The illustrative examples provided herein are not intended to be exhaustive or to limit the invention to the precise forms disclosed.

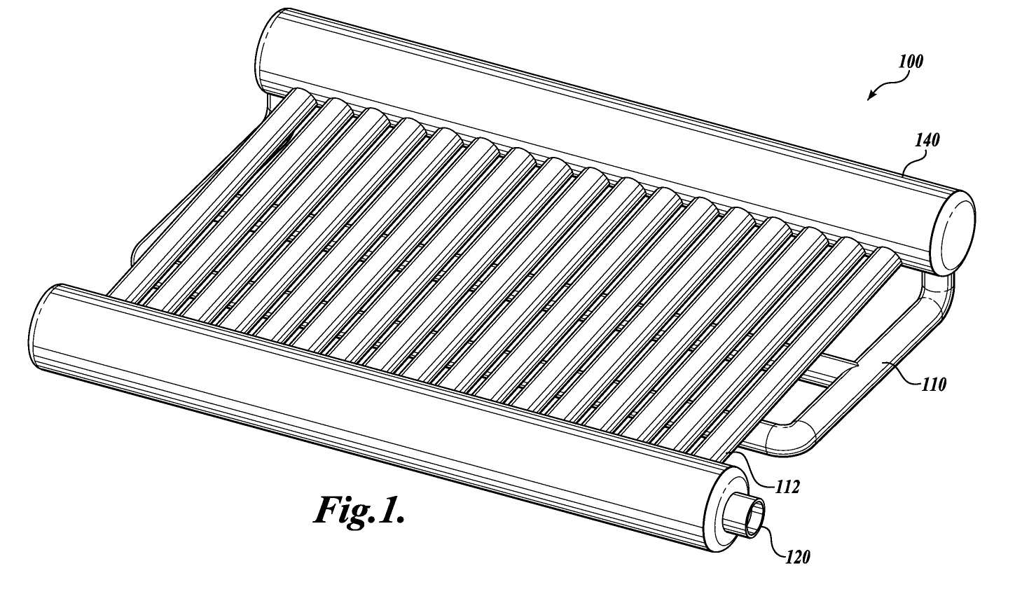

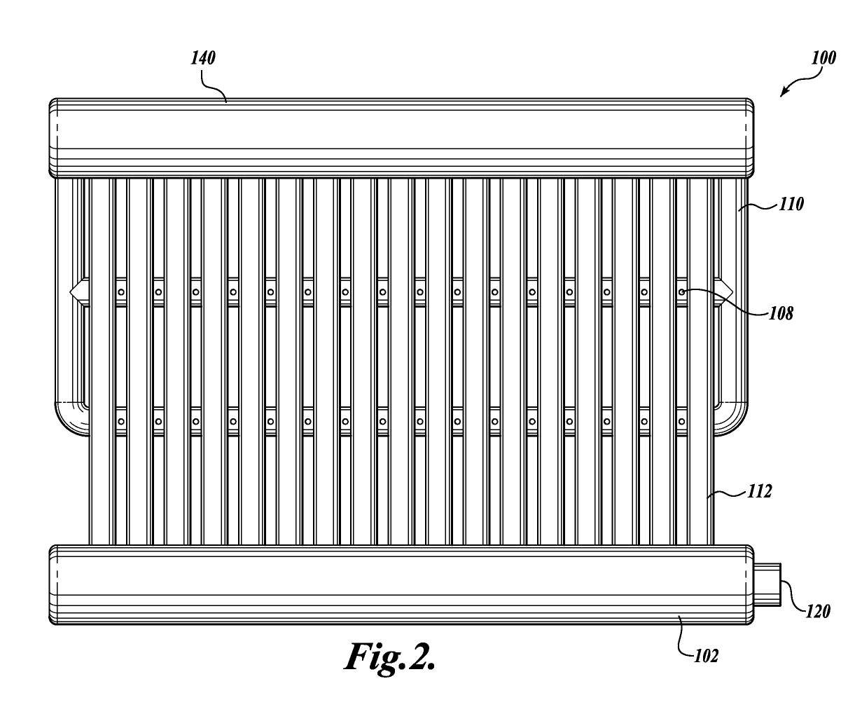

FIGS. 1-3 illustrate an exemplary embodiment of an indoor grill grid apparatus 100 constructed in accordance with aspects of the present invention. In this embodiment, the indoor grill grid apparatus 100 comprises a cooking component 112, a water tank 102, a steam component 110 and a steam reservoir 140.

Referring to FIGS. 1-3, the components of the indoor grill grid apparatus 100 will now be described in detail. The cooking component 112 comprises several elongated members, each elongated member comprising a steam outlet and a water outlet provided at each side of the elongated member. Each elongated member is coupled to the water tank 102. At least one water inlet is provided to an opening of the elongated member such that water can flow from the water tank 102 into the elongated member. In one embodiment, the elongated member is a copper pipe with a predetermined size. However, any suitable material can be used for the elongated steam supply member.

The water flowing from the water tank 102 may fill the hollow interior of each elongated member. In some embodiments, the water level within the hollow interior may be maintained and controlled so that the water does not substantially fill up the entire hollow interior of the elongated member of the cooking component 112. When the grill heat is applied to the cooking component 112 and the cooking component 112 reaches a boiling temperature, the water within the elongated member is vaporized to steam. Subsequently, the steam is supplied through a steam outlet of the elongated member to the steam component 110 (i.e., steam reservoir 140). The steam outlet of each elongated member is provided to another opening of the elongated member such that the steam generated in the elongate member can flow to the steam reservoir 140. In one embodiment, each elongated member is a tube or cylindrical shape having a hollow interior and two openings, one disclosed to the water tank and the other disposed to the steam reservoir 140.

As shown, the steam component 110 further comprises one or more steam supply components. In one embodiment, each steam supply member can have any shape suitable, but preferably, a tube or cylindrical shape having a hollow interior. Each steam supply member is coupled to the steam reservoir 140 or to other steam supply member so that the steam supply member can be a pathway of the steam. The steam in the steam supply component(s) can circulate freely within the steam supply members and the steam reservoir 140. At least one steam inlet is provided to an opening of the steam supply member such that steam can flow from the steam reservoir 140 when a steam pressure is built in the steam reservoir. The steam supply component includes a surface providing a plurality of steam outlets 108. In this embodiment, the steam outlets 108 are provided such that steam can escape upwardly from the steam supply members and be supplied to the cooking component 112.

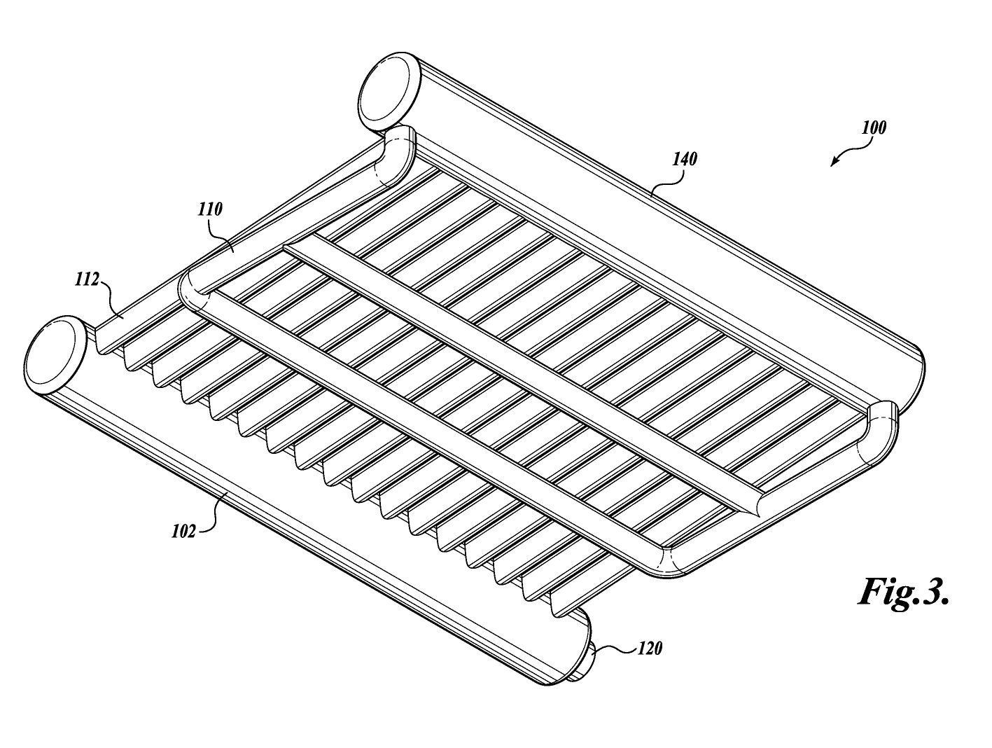

As best shown in FIG. 3, the upper surface of the steam component 110 may be partly coupled to the bottom portion of the cooking component 112. The upper surface of the steam component 110 may or may not be welded with the bottom portion of the cooking component 112. The outlets are preferably provided on portions of the surface of elongated steam supply members which are not attached to the bottom portion of the cooking component 112. In this manner, the cooking component does not block steam from flowing upwardly and thus the food on the surface of the cooking component 112 can be properly exposed to the steam vaporized from the steam component 110.

The upper surface portion of the cooking component 112 is provided for placing and cooking the foods thereon. In one embodiment, the cooking component 112 is a grate made out of stainless steel, copper, steel, porcelain, brass, cast-iron, stone plate, glass, crystal or the like. However, as will be well understood, the cooking surface 112 can be any shape or form suitable for grilling, or for using an indoor stove burner, as long as there are open spaces where steam outlets may be provided on the surface of the steam supply member of the steam component 110.

The water tank 102 is provided to contain a suitable amount of water that can preferably last about two to three cooking hours. The water tank 102 may include a water access opening 120. In one embodiment, a cap (not shown) is provided to securely close the water access opening 120. The water tank 102 can be refilled with water through the water access opening as needed. Additionally or alternatively, the water tank 102 may be directly connected to a water supply source, such as a faucet, a hose connected to a faucet, or the like through the water access opening 120. In some embodiments, the amount of the water contained in the water tank 102 may be controlled by a controlling device attached to the water tank. Such controlling device can be implemented in any conventional manner.

It is contemplated that the water tank is a design choice and thus, any other components that can provide water to the cooking surface can be used instead of the water tank. For example, a particular water source may be directly coupled with the water lets of the elongated steam member with a proper control device.

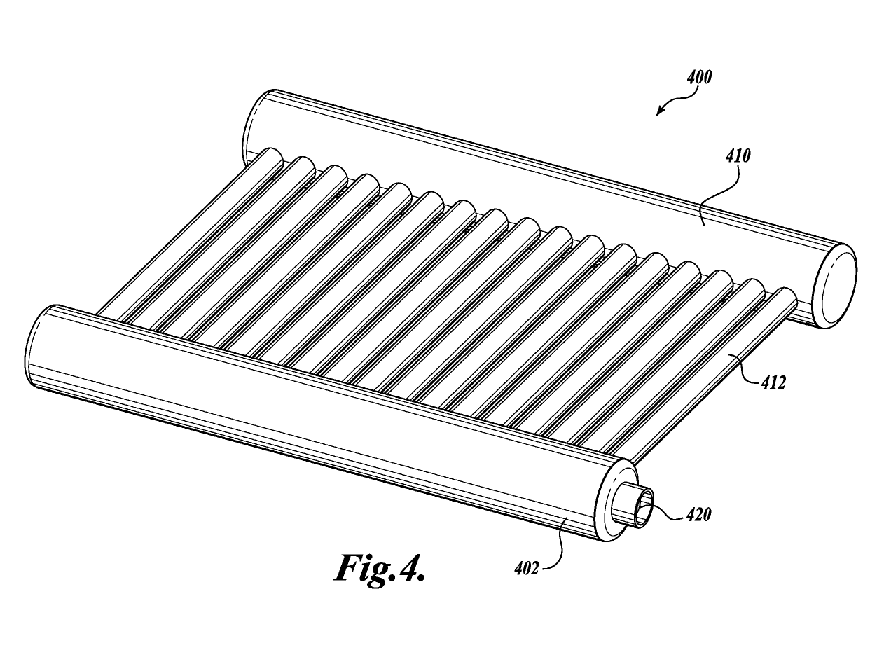

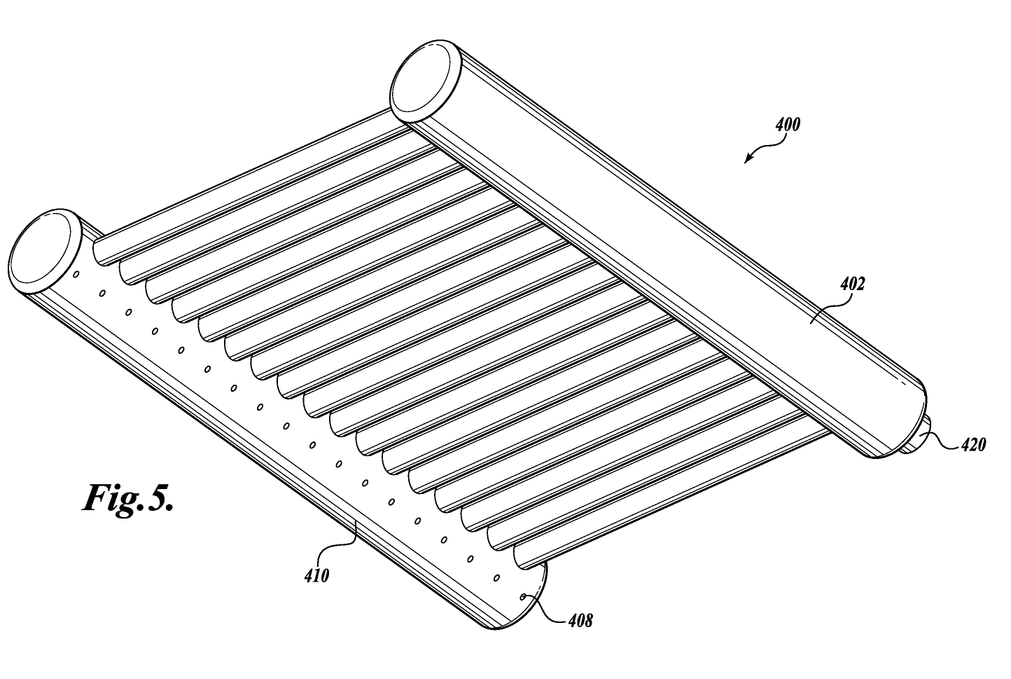

FIGS. 4-6 illustrate another exemplary embodiment of an indoor grill grid apparatus constructed in accordance with aspects of the present invention. In this embodiment, the indoor grill grid apparatus 400 includes a cooking component 412, a water tank 402 and a steam component 410.

Referring to FIGS. 4-6, the components of the indoor grill grid apparatus 400 will now be described in detail. As described above, the indoor grill grid apparatus 400 comprises the steam component 410, which in turn comprises a plurality of steam outlets 408 on the surface thereof. Each steam outlet 408 has openings toward the cooking component so that steam can shoot up from the steam component 410 through the openings, thereby reaching the cooking component 412.

The cooking component 412 comprises elongated members, each of which is a tube type defined by a hollow interior. A first opening coupled to the water tank 402 is provided at the end of each elongated member such that the elongated member can receive water from the water tank 102 through the first opening. The hollow interior of the elongated member carries water from the water tank. When the grill heat is applied to the cooking component and the cooking component reaches a boiling point, the water within the elongated member begins to be vaporized to steam. The steam is supplied from a second opening of the elongated member to the steam component 410. The second opening is coupled to the steam component 410.

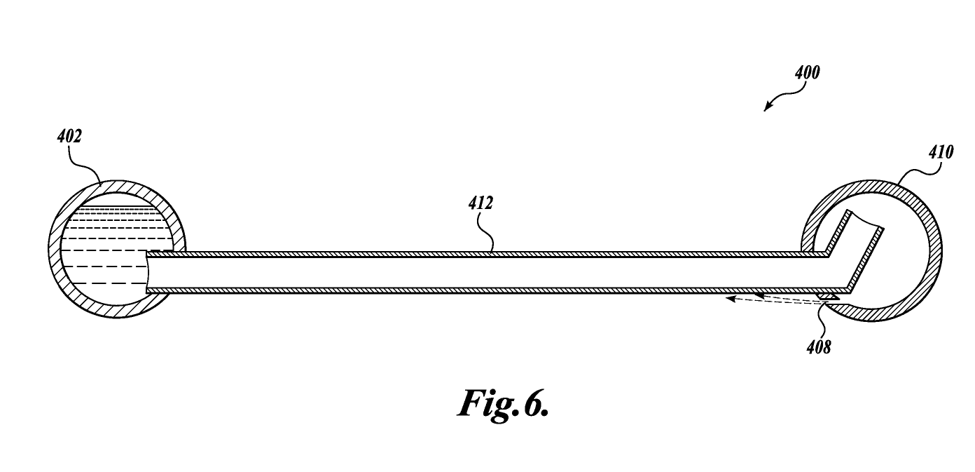

As best shown in FIG. 6, in one particular embodiment, the end portion of the second opening has a shape such that the water filling the hollow interior of the elongated member is prevented from flowing into the steam component 410, while allowing steam to flow into the steam component 410. For example, the end portion of the elongated member is inclined with respect to the axial direction of the steam component. In one embodiment, the elongated member comprises an end portion disposed horizontally with respect to the axial direction of the steam component. Preferably, the bending is within a range of 30-60 degrees from the axial direction of the steam component. As shown, such end portion is inserted into the steam component 410.

In one embodiment, the elongated member is a copper pipe with a predetermined size. However, any suitable material can be used for the elongated member. The water may flow from the water tank to each elongated member and may be filled into the hollow interior of each elongated member. The water level of the hollow interior can be controlled so that the water does not substantially fill up the elongated members, providing space within the elongated member so that steam can be generated and pushed to the steam component. The steam outlets are preferably provided on the portions that are not receiving the elongated member(s) of the cooking component.

Referring now to FIG. 6, a cross sectional view of the embodiment is depicted. As shown, a plurality of steam outlets are provided on a portion of the surface of the steam component 410, for example, the portion under the elongated member is received. In one embodiment, the steam component 410 has a cylindrical shape. In that embodiment, the plurality of steam outlets can be provided on the area located lower than the contact area where each elongated member is received so that when provided, the steam will be flowing upwardly toward the cooking component (i.e., elongated members of the cooking component). As will be appreciated, if the steam outlets are provided further down from the elongated member, the steam will be shooting downwardly toward the gas flame, which can be undesirable.

In one embodiment, the upper portion of each elongated member of the cooking component 412 is designed so that the foods are placed and cooked thereon. In one embodiment, the cooking component 412 is a grate made out of stainless steel, copper, steel, porcelain, brass, cast-iron, stone plate, glass, crystal or the like.

The water tank 402 is provided to contain a suitable amount of water that can preferably last about two to three hours. The water tank 402 may include a water access opening 420 and a cap (not shown) to close the water access opening. The water tank 402 can be refilled with water through the water access opening as needed. Additionally or alternatively, the water tank may be directly connected to a water supply source, such as a faucet, a hose connected to a faucet, or the like.

For sake of brevity, the embodiments of the present invention are discussed in connection with a gas stove burner. As noted above, any type of indoor grill or stove burner can be used to provide heat to generate steam and cook the food.

In one advantageous aspect, the apparatus is provided such that the cooking surface/component 112, 412 can be directly heated by the gas flame of the burner along with the steam generated from the steam component 110, 410. The gas flame and steam, being provided to the apparatus substantially at the same time, can prevent the food from being overcooked, burned or sticking to the cooking surface. In that regard, the cooking surface//component 112, 412 may be maintained about 150° Celsius while the gas flame and the steam are provided. Further, the combination of the steam and the gas flame prevents any food residue from being left on the cooking surface, so fumes and smoke can be minimized, resulting in less or no need to operate a fan to eliminate fumes and smoke. Thus, the cost for the operating fan can be substantially reduced.

Further, when a conventional gas grill grid is used, additional steps such as opening windows or operating some type of fume-removing-equipment are necessary in order to remove fumes or smoke. As previously discussed, when the apparatus is used for grilling, it does not produce any fumes or smoke and, thus, such additional steps are not necessary.

Further, the steam generated from the apparatus can preserve moisture and the natural taste of the food that is grilled on the apparatus. In addition, since the cooking surface of the apparatus can be heated faster compared to the conventional grill grid, both cooking time and gas can be saved. Moreover, the food is less likely to stick to the cooking surface of the apparatus. In this manner, the original shape of the food can be preserved and cleaning the apparatus is easy.

It is noted that the apparatus can comprise additional components, such as an oil drainer, a steam tank area where the generated steam can be contained and the like.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A grid apparatus suitable for indoor grilling, the grid apparatus comprising:
a cooking component provided for placing and cooking food thereon, the cooking component comprising a plurality of elongated members connected to the water tank, each elongated member comprising:
a water inlet for receiving water from a water tank; and
a hollow interior where the water can flow from the water tank through the water inlet,
wherein as the cooking component is heated by a stove burner and the cooking component reaches a boiling temperature, the water is vaporized to steam, thereby the steam being generated within the hollow interior of the elongated member; and
a steam component including:
a steam reservoir for receiving steam, the steam reservoir including a plurality of steam inlets, each steam inlet coupled to an opening disposed at a side of a corresponding elongated member of the cooking component; and
a steam supply member including a surface where a plurality of steam outlets are provided thereon, the steam supply member coupled to the steam reservoir,
wherein after a steam pressure is built within the steam reservoir, the steam fills the steam supply member, thereby the steam flowing out from the steam supply member through the plurality of steam outlets.

2. The grid apparatus of claim 1, wherein the steam supply member includes at least one opening disposed at an end potion of the steam supply member and the end potion is coupled to the steam reservoir.

3. The grid apparatus of claim 1, wherein the upper surface of the steam component is coupled to the bottom portion of the cooking component such that the steam outlets are provided on the portions that are not blocked by the cooking component.

4. The grid apparatus of claim 1, wherein the cooking component is a grate made of stainless steel, copper, steel, porcelain, brass, cast-iron, stone plate, glass, or crystal.

5. The grid apparatus of claim 1, wherein the water tank comprises a water access opening.

6. The grid apparatus of claim 1, wherein the water access opening is coupled to a water source.

7. The grid apparatus of claim 1, wherein the steam reservoir receives the steam through the plurality of steam inlets from the elongated members of the cooking component, after the water contained in the hollow interior of the elongated member being vaporize to steam.

8. The grid apparatus of claim 1, wherein the steam outlets are provided upwardly toward the cooking component such that a substantial amount of the steam can be supplied to the cooking component.

9. The grid apparatus of claim 1, wherein the stove burner is a gas stove, an electric stove, or a charcoal stove.

10. A grant apparatus suitable for indoor grilling, the grant apparatus comprising:
a water tank for storing and for supplying water;
a cooking component including:
a plurality of elongated members connected to the water tank, each elongated member comprising a hollow interior for carrying the water supplied from the water tank,
wherein as the cooking component reaches a boiling temperature, the water contained in the elongated member is vaporized, thereby steam being generated within the hollow interior of the elongated member, and
a steam component comprising:
a plurality of steam outlets provided thereon, each steam outlet including an opening for supplying the steam upwardly so that the elongated members of the cooking component are exposed to the steam; and
a hollow interior for receiving the steam from the elongated member of the cooking component,
wherein the steam flows into the steam component once the water contained in the elongated members is vaporized.

11. The grant apparatus of claim 10, wherein, the elongated member comprises a cooking surface provided for placing and cooking food thereon.

12. The grant apparatus of claim 10, when a steam pressure is built within the hollow interior of the steam component, the plurality of steam outlets supply the steam upwardly in a direction toward to the cooking component.

13. The grant apparatus of claim 10, wherein the cooking component is a grate made of stainless steel, copper, steal, porcelain, brass, cast-iron, stone plate, glass, or crystal.

14. The grant apparatus of claim 10, wherein the elongated member has a first end portion received by the stream component, the first end portion being constructed such that the water carried within the elongated member is prevented from flowing into the steam component.

15. The grant apparatus of claim 14, wherein the first end portion is disposed upwardly with respect to an axial direction of the steam component.

16. The grant apparatus of claim 10, wherein the elongated member has a second end portion coupled to the water tank, the second end portion including an inlet through which the water is received.

17. An indoor grill grid apparatus comprising:
a cooking component provided for placing and cooking food thereon, cooking component including a plurality of elongated members, each elongated member comprising:
a water inlet for receiving water;
a hollow interior containing the water flowing through the water inlet;
a steam component including:
a plurality of steam inlets, each steam inlet coupled to a corresponding elongated member of the cooking component;
a steam reservoir for receiving steam through the plurality of steam inlets;
a steam supply member including a surface where a plurality of steam outlets are provided thereon, the steam supply member coupled to the steam reservoir; and
wherein as the cooking component is heated by an indoor stove burner and the cooking component reaches a boiling temperature, the water is vaporized to steam, thereby the steam filling the steam reservoir through the steam inlets, and
wherein the steam flows out from the steam outlets after a steam pressure is built within the steam reservoir.

18. The indoor grill grid apparatus of claim 17, wherein a first surface of the steam component is coupled to a first portion of the cooking component such that the steam outlets can be provided on the portions that are not blocked by the first portion cooking surface.

19. The indoor grill grid apparatus of claim 17, wherein the first surface of the steam component is an upper surface and the first portion of the cooking component is a bottom portion.

20. The indoor grill grid apparatus of claim 17, wherein the water inlet of the elongated member is coupled to a water tank or a water source.
